(19) United States
(12) Patent Application Publication
(10) Pub. No.: US 2018/0286281 A1
(43) Pub. Date: Oct. 4, 2018

(54) Universal mathematical scale A1. and A2. set

(71) Applicant: Carl Abdullah Islam Muhammad, Memphis, TN (US)

(72) Inventor: Carl Abdullah Islam Muhammad, Memphis, TN (US)

(21) Appl. No.: 15/530,974

(22) Filed: Mar. 31, 2017

(51) Int. Cl. G09B 23/02

(52) U.S. Cl. CPC G09B 23/02

(57) ABSTRACT

By sliding the triangle on A1 under any number on A2., the triangle gives the answers to many different problems at one single move.

For example:

Place the triangle under 9 of scale A2., one will have the answers to 19 different problems.

Based on the instructions of the scales, when one finds the answer to one problem, one finds the answers to multiple problems at once.

Therefore, the triangle knows all.

It has an indefinite number vocabulary system like no other invention.

Scale A2., Numbers are written down horizontally {0 through 19} with the same space between each number and

Scale A1. must have the same distance as A2.

By doing this, the numbers will, line-up vertically.

And once lined-up, the pyramid or triangle knows all.

One can master addition and subtraction with this invention in a small amount of time.

Scale A1. has a pyramid base on it that is also called a triangle. The pyramid base or the triangle is at the center of A1 with a zero (0) on top and a one (1) on top of the zero pointing to a particular or a certain number on Scale A2.

For example:

If the triangle or pyramid base with the zero and one on top of the zero point to 9 then, the answer to all the problems are equal to 9.

Scale A2. has 0 Through 19.

Scale A1. has a triangle or the base of a pyramid at the center of it with a zero and a one (1) on top of the zero and it gives the answer to all of the problems when the numbers are lined-up proper with each other in addition and subtraction.

If you place the triangle on Scale A1. under any number on Scale A2, it would be the answer to all the problems.

For example:

Place the triangle under (7) seven on Scale A2, all the answers would be (7) seven on both sides of the triangle addition and subtraction.

The Scale A2. goes from zero (0) to 19 and the number system repeats itself after 9+9 which is 18 and that is highest it goes.

Once again, to find all the numbers that equal to a certain number, you just place the triangle under any number under Scale A2.

Step 2.

To find individual problems such as 9+5 or 5+9

### Answer:

Find 9 on the left side of the triangle and then place it under 5 on Scale A2 and then look at the triangle and that is the answer 14.

Or place 5 on the left side of the triangle under 9 on Scale A2, the answer would be again 14 and that is the answer to all the problems when properly lined-up.

Another example:

7+9

Notice or go to 7 or 9 on the left side of the triangle And if you go to (7) seven then, place (7) under 9 on Scale A2 and then look at the triangle

And the triangle gives you the answer which is 16 and also the answer to all the problems.

For Subtraction Problems

### EXAMPLE

9−9

Look at the right side of the triangle on side A1. and find −9 and then place −9 under 9 on Scale A2 and then go to the triangle and that will be the answer which is (0) zero.

5−5=0

Place −5 on the right side of the triangle under 5 on Scale A2 and then notice the position of the triangle.

It is on (0) zero. (Right)?

And then, all the answers are zero (0).

I want the function of this invention protected and I want the design of this invention protected.

The Universal Mathematical Scale A1 and A2 design.

Scale A2. Has 0 Through 19

Scale A1. Has a triangle in the middle of it and on the left side of the triangle is 1 through 9 from right to left. And on the right side of the triangle are numbers −1 through −10.

This is my invention of the Universal Mathematical Scale or Calculating Scale. Scale A1. and A2. is a complete set. And you can use as many sets you want to calculate with.

1. This is my invention of the Universal Mathematical Scale A1. and A2. Set which includes A2. {0 through 19 or Indefinite Numbers} and A1. scale that has a triangle in the middle of it. On the left side of the triangle is {1 through 9} from right to left and also, on the right side of the triangle are Numbers {−1 through −10 or indefinite Minus Numbers} in which the triangle gives the solutions to many different problems when placed under a number on Scale A2.
